(19) United States
(12) Patent Application Publication
(10) Pub. No.: US 2022/0230097 A1
(43) Pub. Date: Jul. 21, 2022

(54) DEVICE AND METHOD FOR DATA-BASED REINFORCEMENT LEARNING

(71) Applicant: AGILESODA INC., Seoul (KR)

(72) Inventors: Yong CHA, Seoul (KR); Cheol-Kyun RHO, Seoul (KR); Kwon-Yeol LEE, Seoul (KR)

(73) Assignee: AGILESODA INC., Seoul (KR)

(21) Appl. No.: 17/629,133

(22) PCT Filed: Feb. 28, 2020
(86) PCT No.: PCT/KR2020/002927

§ 371 Date: Jan. 21, 2022

(30) Foreign Application Priority Data
Jul. 23, 2019 (KR) 10-2019-0088942

(51) Int. Cl. G06N 20/00

(52) U.S. Cl. CPC G06N 20/00

(57) ABSTRACT

Disclosed is a device for data-based reinforcement learning. The disclosure allows an agent to learn a reinforcement learning model so as to maximize a reward for an action selectable according to a current state in a random environment, wherein a difference between a total variation rate and an individual variation rate for each action is provided as a reward for the agent.

### TECHNICAL FIELD

The disclosure relates to a device and a method for data-based reinforcement learning and, more specifically, to a device and a method for data-based reinforcement learning, wherein a difference in overall variation is defined as a reward and provided according to variations caused by actions in individual cases, based on data in actual businesses, in connection with data reflected during model learning.

### BACKGROUND ART

Reinforcement learning refers to a learning method for handling an agent who accomplishes a metric while interacting with the environment, and is widely used in fields related to robots or artificial intelligence.

The purpose of such reinforcement learning is to find out what action is to be performed by a reinforcement learning agent, who is the subject of learning actions, in order to receive more rewards.

That is, it is learned what should be done to maximize rewards even in the absence of a fixed answer, and processes of maximizing rewards through trial and error are experienced, instead of doing predetermined actions in situations having a clear relation between input and output.

In addition, the agent successively selects actions as time steps pass, and receives a reward based on the influence of the actions on the environment.

FIG. 1 is a block diagram illustrating the configuration of a reinforcement learning device according to the prior art.

as illustrated in FIG. 1, a method for an agent 10 to determine an action A through learning of a reinforcement learning model may be learned, each action A influences the next state S, and the degree of success may be measured as a reward R.

That is, the reward is a point of reward to an action determined by the agent 10 according to a specific state when conducting learning through the reinforcement learning model, and is a kind of feedback to intent determined by the agent 10 as a result of learning.

In addition, the manner of rewarding heavily influences the learning result, and, through reinforcement learning, the agent 10 takes actions to maximize future rewards.

However, the reinforcement learning device according to the prior art has a problem in that, since learning proceeds on the basis of rewards determined unilaterally in connection with metric accomplishment in a given situation, only one action pattern can be taken to accomplish the metric.

In addition, the reinforcement learning device according to the prior art has another problem in that rewards need to be separately configured for reinforcement learning because, in the case of a clear environment (for example, games) which is frequently applied for reinforcement learning, rewards are determined as game scores, but actual business environments are not similar thereto.

In addition, the reinforcement learning device according to the prior art has another problem in that reward points are unilaterally determined and assigned to actions (for example, +1 point if correct, −2 points if wrong), and users are required to designate appropriate reward values while watching learning results, and thus need to repeat and experiment reward configurations conforming to business objectives every time.

In addition, the reinforcement learning device according to the prior art has another problem in that, in order to develop an optimal model, an arbitrary reward point is assigned and is readjusted while watching the learning result through many times of trial and error, and massive time and computing resources are consumed for trial and error in some cases.

### DISCLOSURE OF INVENTION

### Technical Problem

In order to solve the above-mentioned problems, it is an aspect of the disclosure to provide a device and a method for data-based reinforcement learning, wherein a difference in overall variation is defined as a reward and provided according to variations caused by actions in individual cases, based on data in actual businesses, in connection with data reflected during model learning.

### Solution to Problem

In accordance with an aspect, a data-based reinforcement learning device according to an embodiment of the disclosure may include: an agent configured to distinguish case 1 in which a reinforcement learning metric is higher than an overall average, case 2 in which the reinforcement learning metric has no variation compared with the overall average, and case 3 in which the reinforcement learning metric is lower than the overall average, and configured to determine an action such that the reinforcement learning metric is maximized with regard to individual piece of data corresponding to stay with regard to a current limit, up by a predetermined value compared with the current limit, and down by a predetermined value compared with the current limit, in each case; and a reward control unit configured to calculate a difference value between an individual variation rate of the reinforcement learning metric, calculated for the action of individual piece of data determined by the agent, and a total variation rate of the reinforcement learning metric, and provide, as a reward for each action of the agent, the calculated difference value between the individual variation rate of the reinforcement learning metric and the total variation rate of the reinforcement learning metric, wherein the calculated difference value is converted into a standardized value between “0” and “1” and provided as a reward.

Further, the reinforcement learning metric according to an embodiment may be configured as a rate of return.

Further, the reinforcement learning metric according to an embodiment may be configured as a limit exhaustion rate.

In addition, the reinforcement learning metric according to an embodiment may be configured as a loss rate.

In addition, the reinforcement learning metric according to an embodiment may be obtained such that an individual reinforcement learning metric is configured with a predetermined weight value or different weight values.

In addition, the reinforcement learning metric according to an embodiment may be configured to determine a final reward by the calculation of the configured weight value of the individual reinforcement learning metric with a standardized variation value,

and the final reward may be determined based on the following formula

(weight 1*variation value of standardized rate of return)+(weight 2*variation value of standardized limit exhaustion rate)−(weight 3*variation value of standardized loss rate).

In addition, a data-based reinforcement learning method according to an embodiment of the disclosure may include: a) allowing an agent to distinguish case 1 in which an reinforcement learning metric is higher than an overall average, case 2 in which the reinforcement learning metric has no variation compared with the overall average, and case 3 in which the reinforcement learning metric is lower than the overall average, and to determine an action such that the reinforcement learning metric is maximized with regard to individual piece of data corresponding to stay with regard to a current limit, up by a predetermined value compared with the current limit, and down by a predetermined value compared with the current limit, in each case; b) allowing a reward control unit to calculate a difference value between an individual variation rate of the reinforcement learning metric, calculated for the action of the individual piece of data determined by the agent, and a total variation rate of a rate of return; and c) allowing the reward control unit to provide, as a reward for each action of the agent, the calculated difference value between the individual variation rate of the reinforcement learning metrics and the total variation rate of the reinforcement learning metric, wherein the calculated difference value is converted into a standardized value between “0” and “1” and provided as a reward.

Further, the reinforcement learning metric according to an embodiment may be configured as a rate of return.

In addition, the reinforcement learning metric according to an embodiment may be configured as a limit exhaustion rate.

In addition, the reinforcement learning metric according to an embodiment may be configured as a loss rate.

In addition, the reinforcement learning metric according to an embodiment may be obtained such that an individual reinforcement learning metric is configured with a predetermined weight value or different weight values.

In addition, the reinforcement learning metric according to an embodiment may determine a final reward by the calculation of the configured weight value of the individual reinforcement learning metric with a standardized variation value, and the final reward may be determined based on the following formula

(weight 1*variation value of standardized rate of return)+(weight 2*variation value of standardized limit exhaustion rate)−(weight 3*variation value of standardized loss rate).

### Advantageous Effects of Invention

The disclosure is advantageous in that a difference in overall variation is defined as a reward and provided according to variations caused by actions in individual cases, based on data in actual businesses, in connection with data reflected during model learning such that operations/processes in which the user manually makes readjustment while watching learning results without arbitrarily assigning reward points are omitted, thereby alleviating the difficulty related to repeated experiments of reward configurations conforming to business objectives every time.

In addition, the disclosure is advantageous in that, with regard to a defined metric of reinforcement learning, a difference from the overall variation resulting from individual variations regarding respective actions is defined as a reward, and the metric is matched with the accomplishment, thereby shortening the period of time for developing a model through reinforcement learning.

In addition, the disclosure is advantageous in that the time necessary to configure reward points, during which reward points are assigned arbitrarily to develop an optical model, and the process of trial and error are substantially reduced, thereby reducing computing resources and time necessary for reinforcement learning and reward point readjustment.

In addition, the disclosure is advantageous in that a difference regarding a variation of a metric is defined as a reward according to an action defined by configuring a metric of reinforcement learning such that the metric and the reward are interlinked, thereby enabling intuitive understanding of reward points.

In addition, the disclosure is advantageous in that a reward may be understood as an impact measure of a business such that merits before and after reinforcement learning can be compared and determined quantitatively.

In addition, the disclosure is advantageous in that, with regard to a metric, a corresponding reward may be defined, and feedback regarding an action of reinforcement learning may be naturally connected.

In addition, the disclosure is advantageous in that, when the metric of reinforcement learning is to improve the rate of return in the case of a financial institution (for example, bank, credit card company, or insurance company), a difference regarding a variation of the rate of return is automatically configured as a reward according to a defined action; when the metric of reinforcement learning is to improve the limit exhaustion rate, a difference regarding a variation of the limit exhaustion rate is automatically configured as a reward according to a defined action; or when the metric of reinforcement learning is to reduce the loss rate, a difference regarding a variation of the loss rate is automatically configured as a reward according to a defined action, thereby maximizing credit profitability.

In addition, the disclosure is advantageous in that a different weight is configured for each specific metric such that a differentiated reward can be provided according to the user's importance.

### BRIEF DESCRIPTION OF DRAWINGS

FIG. 1 is a block diagram indicating the configuration of a reinforcement learning device according to the prior art;

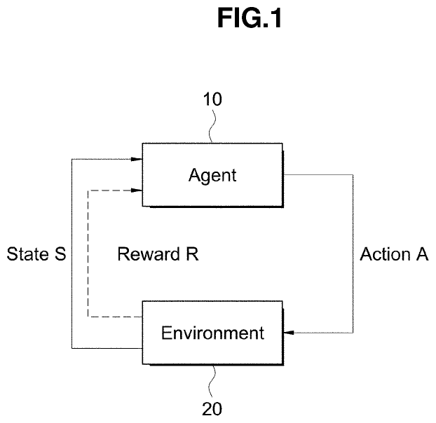

FIG. 2 is a block diagram indicating the configuration of a data-based reinforcement learning device according to an embodiment of the disclosure;

FIG. 3 is a flowchart illustrating a data-based reinforcement learning method according to an embodiment of the disclosure;

FIG. 4 is an exemplary diagram for describing a data-based reinforcement learning method according to the embodiment of FIG. 3;

FIG. 5 is another exemplary diagram for describing a data-based reinforcement learning method according to the embodiment of FIG. 3;

FIG. 6 is still another exemplary diagram for describing a data-based reinforcement learning method according to the embodiment of FIG. 3; and

FIG. 7 is still further another exemplary diagram for describing a data-based reinforcement learning method according to the embodiment of FIG. 3.

### BEST MODE FOR CARRYING OUT THE INVENTION

Hereinafter, a preferred embodiment of a data-based reinforcement learning device and method according to an embodiment of the disclosure will be described in detail with reference to drawings attached herein.

The expression “including” a certain part in the present specification may be understood as further including other elements rather than excluding other elements.

In addition, terms such as “ . . . unit”, terms ending with suffixes “ . . . er” and “ . . . or”, “ . . . module”, and the like refer to a unit which processes at least one function or operation, and may be distinguished by hardware, software, or a combination of hardware and software.

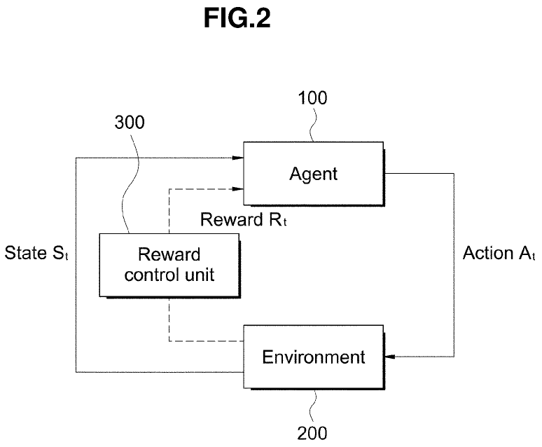

FIG. 2 is a block diagram indicating the configuration of a data-based reinforcement learning device according to an embodiment of the disclosure.

As shown in FIG. 2, a data-based reinforcement learning device according to an embodiment of the disclosure includes an agent 100 and a reward control unit 300, and is configured to allow the agent 100 to learn a reinforcement learning model to maximize a reward for an action selectable according to a current state in a random environment 200, and to allow the reward control unit 300 to provide a difference between a total variation rate and an individual variation rate for each action as a reward for the agent 100.

The agent 100 learns a reinforcement learning model to maximize a reward for an action selectable according to a current state in a given specific environment 200.

In a reinforcement learning, when a specific goal (metric) is configured, the direction of learning for achieving the configured metric is configured.

For example, if a goal is to generate an agent for maximization of a rate of return, a reinforcement learning allows generation of a final agent capable of achieving a high rate of return by considering a reward according to various states and actions through learning.

That is, maximizing the rate of return is an ultimate goal (or metric) which the agent 100 intends to achieve through the reinforcement learning.

To this end, the agent 100 is in a state (St) of the agent itself and has a possible action (At) at a random time-point t, and here, the agent 100 takes some actions and receives a new state (St+1) and a reward from the environment 200.

The agent 100 learns, based on such interaction, a policy that maximizes an accumulated reward value in a given environment 200.

A reward control unit 300 is configured to provide, as a reward, the agent 100 with a difference between a total variation rate and an individual variation rate for each action according to the learning of the agent 100.

That is, the reward control unit 300 performs reward learning for calculating a reward with feedback of an action according to a state for finding an optimal policy within the learning of the agent 100, by using a reward function of providing, as a reward, a difference between a total variation and an individual variation of a corresponding metric for each action.

In addition, the reward control unit 300 may convert a variation value into a preconfigured standardized value to configure an individual reward system of the identical unit.

In addition, the reward control unit 300 may provide data, which is reflected during the learning of a reinforcement learning model, by defining a difference between a total variation and an individual action variation for each case, as a reward, based on data obtained from actual business, and thus may omit the work process of randomly assigning a reward score and re-adjusting the reward after viewing a learning result.

In addition, a variation value, which is calculated by the reward control unit 300, allows a metric of a reinforcement learning and a reward to be linked (or aligned) to enable intuitive understanding of the reward score.

Hereinafter, a data-based reinforcement learning method according to an embodiment of the disclosure will be described.

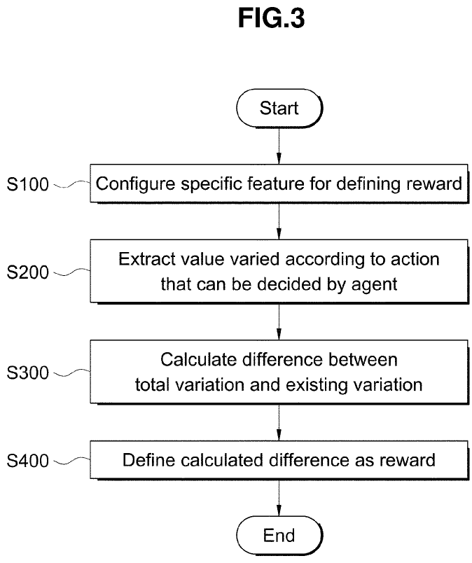

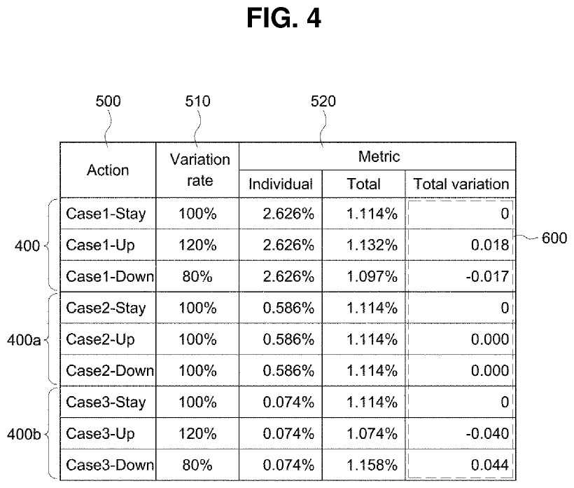

FIG. 3 is a flowchart illustrating a data-based reinforcement learning method according to an embodiment of the disclosure, and FIG. 4 is an exemplary diagram for describing a data-based reinforcement learning method according to the embodiment of FIG. 3.

FIG. 4 is only an example of describing an embodiment of the disclosure, but is not limited thereto.

Referring to FIG. 2 to FIG. 4, first, a specific feature for defining a reward is configured in operation S100.

In FIG. 4, for example, a variation rate 510 with regard to an action 500 is defined by the following three types of data corresponding to stay with regard to a current limit, up 20% compared with the current limit, and down 20% compared with the current limit, and a reinforcement learning metric 520 is distinguished such that case 1 400 in which the reinforcement learning metric is higher than an overall average, case 2 400a in which the reinforcement learning metric has no variation compared with the overall average, and case 3 400b in which the reinforcement learning metric is lower than the overall average.

Here, the reinforcement learning metric 520 is a rate of return.

In operation S100, as shown in FIG. 4, configuration of a feature according to action variation of an individual case in each distinguished case is performed.

The present embodiment describes, for convenience of explanation, an embodiment in which a specific column for which a reward is to be defined is configured as an action of case 1-up column.

After performing operation S100, the reward control unit 300 extracts a variation value according to an action that can be decided through learning of a reinforcement learning model through the agent 100, in operation S200.

In operation S200, for example, in case 1 400 in which the reinforcement learning metric is higher than an overall average, “1.132%”, which is a total variation value according to individual actions for a case 1-up column, is extracted.

With regard to an action of case 1-stay column, the reward control unit 300 calculates “0.018”, which is a difference value between a total variation value “1.114%” and the total variation value “1.132%” according to the extracted action, in operation S300.

Here, the calculated value may be standardized to be a value between “0” and “1” through standardization to configure an individual reward system of an identical unit.

The difference value, which is calculated in operation S300, is provided as a reward 600 to the agent 100 by the reward control unit 300 in operation S400.

That is, a difference between a total variation and an individual action variation for each case is defined as a reward and provided, and thus it is possible to provide a reward score without performing a process of randomly assigning a reward score and re-adjusting the reward score according to learning results.

In addition, a variation difference provided by the reward control unit 300 and a reinforcement learning metric 520 (goal) are linked to enable intuitive understanding of a reward score, and effects before and after the application of the reinforcement learning can be quantitatively compared and determined.

On the other hand, in this embodiment, a reinforcement learning metric 520, for example, a reward for the rate of return has been described as a final reward, but it is not limited thereto, and the final reward may be calculated for a plurality of metrics such as limit exhaustion rate and loss rate, for example.

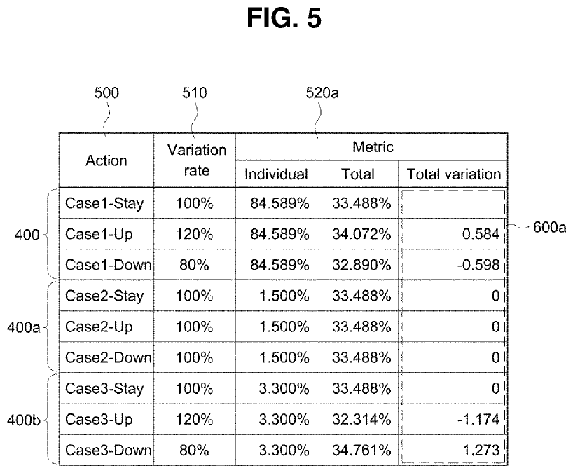

FIG. 5 is another exemplary diagram for describing a data-based reinforcement learning method according to the embodiment of FIG. 3.

In FIG. 5, for example, a variation rate 510 with regard to an action 500 is defined by the following three types of data corresponding to stay with regard to a current limit, up 20% compared with the current limit, and down 20% compared with the current limit, and a reinforcement learning metric 520a is distinguished such that case 1 400 in which the reinforcement learning metric is higher than an overall average, case 2 400a in which the reinforcement learning metric has no variation compared with the overall average, and case 3 400b in which the reinforcement learning metric is lower than the overall average.

In FIG. 5, the reinforcement learning metric 520a may be configured as a limit exhaustion rate.

For example, in case 1 400 in which the reinforcement learning metric is higher than an overall average, with regard to case 1-up column, “34.072%”, which is a total variation value according to individual actions, is extracted.

With regard to an action of case 1-stay column, the reward control unit 300 calculates “0.584”, which is a difference value between a total variation value “33.488%” and the extracted variation value “34.072%” according to the case 1-up action, and provides the calculated difference value as a reward 600a.

Here, the calculated value may be standardized to be a value between “0” and “1” through standardization to configure an individual reward system of an identical unit.

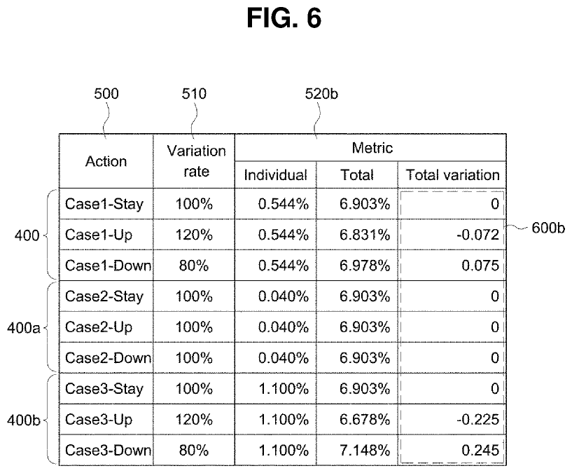

In addition, FIG. 6 is still another exemplary diagram for describing a data-based reinforcement learning method according to the embodiment of FIG. 3.

In FIG. 6, for example, a variation rate 510b with regard to an action 500b is defined by the following three types of data corresponding to stay with regard to a current limit, up 20% compared with the current limit, and down 20% compared with the current limit, and a reinforcement learning metric 520b is distinguished such that case 1 400 in which the reinforcement learning metric is higher than an overall average, case 2 400a in which the reinforcement learning metric has no variation compared with the overall average, and case 3 400b in which the reinforcement learning metric is lower than the overall average.

In FIG.6, the reinforcement learning metric 520b may be configured as a loss rate.

For example, in case 1 400 in which the reinforcement learning metric is higher than an overall average, with regard to a case 1-up column, “6.831%”, which is a total variation value according to individual actions, is extracted.

With regard to an action of case 1-stay column, the reward control unit 300 calculates “0.072”, which is a difference value between a total variation value “6.903%” and the extracted variation value “6.831%” according to the case 1-up action, and provides the calculated difference value as a reward 600b.

Here, the calculated value may be standardized to be a value between “0” and “1” through standardization so as to configure an individual reward system of an identical unit.

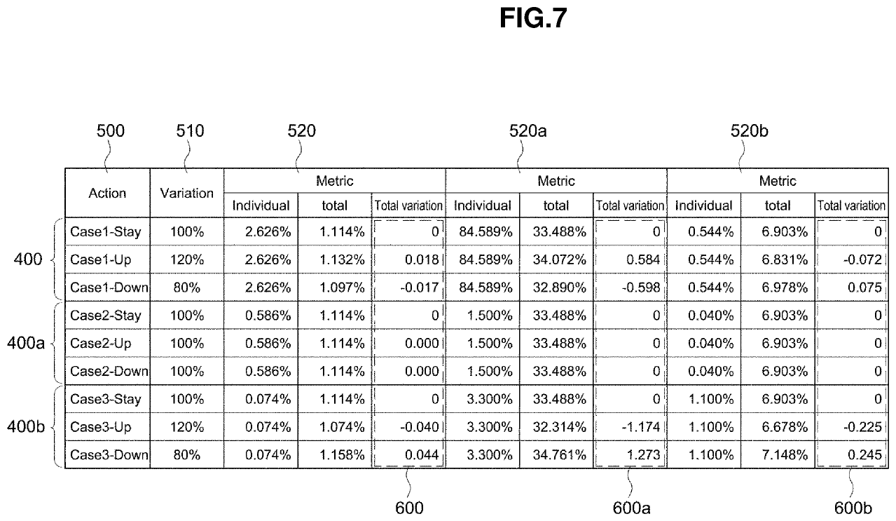

Further, FIG. 7 is still further another exemplary diagram for describing a data-based reinforcement learning method according to the embodiment of FIG. 3.

As shown in FIG. 7, a variation rate 510b with regard to an action 500b is defined by the following three types of data corresponding to stay with regard to a current limit, up 20% compared with the current limit, and down 20% compared with the current limit, and the reinforcement learning metric 520, 520a, 520b relating to a rate of return, a limit exhaustion rate, and a loss rate is distinguished such that case 1 400 in which the reinforcement learning metric is higher than an overall average, case 2 400a in which the reinforcement learning metric has no variation compared with the overall average, and case 3 400b in which the reinforcement learning metric is lower than the overall average.

In addition, a predetermined weight value or different weight values are assigned to each of the rate of return, limit exhaustion rate, and loss rate, and a variation value of standardized rate of return, a variation value of standardized limit exhaustion rate, a variation value of standardized loss rate are reflected to each of the assigned weight values to calculate a final reward.

A final reward may be calculated based on the following formula.

The final reward may be calculated in various methods through a preconfigured formula, such as, final reward=(weight 1*variation value of standardized rate of return)+(weight 2*variation value of standardized limit exhaustion rate)−(weight 3*variation value of standardized loss rate).

Therefore, data reflected during the learning of a reinforcement learning model may be provided by defining a difference between a total variation and an individual action variation for each case, as a reward, based on data obtained from the actual business, thus it is possible to omit the work process of manually re-adjusting a reward score by a user after viewing a learning result without randomly assigning the reward score.

Further, with respect to the defined reinforcement learning goal (metric), a difference between a total variation and an individual action variation as a reward, so that a reinforcement learning can be performed without adjustment (or re-adjustment) of the reward.

In addition, the goal of reinforcement learning is configured and the difference in variation of the goal according to a defined action is defined as a reward, and thus the goal of reinforcement learning and the reward are linked, so as to enable intuitive understanding of a reward score.

Although described with reference to a preferred embodiment of the disclosure, a person skilled in the art can understand that various changes and/or modifications can be made to the invention without departing from the spirit and domain of the disclosure described in the following claims.

In addition, the reference numerals in the claims of the disclosure are only described for clarity and convenience of description, and are not limited thereto, and in the process of describing the embodiment, the thickness of the lines, the size of elements, and the like shown in the drawings may be exaggerated for clarity and convenience of description. Further, the above-mentioned terms are terms defined in consideration of functions in the disclosure, which may vary depending on the intention or practice of a user or operator, and thus the interpretation of these terms should be made based on the details throughout the present specification.

### DESCRIPTION OF REFERENCE NUMERALS

100: Agent

200: Environment

300: Reward control unit

400: Case 1

400a: Case 2

400b: Case 3

500: Action

510: Variation rate

520: Metric

600: Reward

1. A data-based reinforcement learning device comprising:
an agent (100) configured to distinguish case 1 (400, 400, 400) in which a reinforcement learning metric (520, 520a, 520b) is higher than an overall average, case 2 (400a, 400a, 400a) in which the reinforcement learning metric (520, 520a, 520b) has no variation compared with the overall average, and case 3 (400b, 400b, 400b) in which the reinforcement learning metric (520, 520a, 520b) is lower than the overall average, and configured to determine an action such that the reinforcement learning metric (520, 520a, 520b) is maximized with regard to individual piece of data corresponding to stay with regard to a current limit, up by a predetermined value compared with the current limit, and down by a predetermined value compared with the current limit, in each case; and
a reward control unit (300) configured to calculate a difference value between an individual variation rate of the reinforcement learning metric (520, 520a, 520b), calculated for the action of individual piece of data determined by the agent (100), and a total variation rate of the reinforcement learning metric (520, 520a, 520b), and provide, as a reward for each action of the agent (100), the calculated difference value between the individual variation rate of the reinforcement learning metric (520, 520a, 520b) and the total variation rate of the reinforcement learning metric (520, 520a, 520b),
wherein the calculated difference value is converted into a standardized value between “0” and “1” and provided as a reward.

2. The data-based reinforcement learning device of claim 1, wherein the reinforcement learning metric (520) is configured as a rate of return.

3. The data-based reinforcement learning device of claim 2, wherein the reinforcement learning metric (520a) is configured as a limit exhaustion rate.

4. The data-based reinforcement learning device of claim 3, wherein the reinforcement learning metric (520b) is configured as a loss rate.

5. The data-based reinforcement learning device of claim 4, wherein the reinforcement learning metric (520, 520a, 520b) is obtained such that the individual reinforcement learning metric is configured with a predetermined weight value or different weight values.

6. The data-based reinforcement learning device of claim 5, wherein the reinforcement learning metric (520, 520a, 520b) is configured to determine a final reward by the calculation of the configured weight value of the individual reinforcement learning metric with a standardized variation value,
wherein the final reward is determined based on the following formula (weight 1*variation value of standardized rate of return)+(weight 2*variation value of standardized limit exhaustion rate)−(weight 3*variation value of standardized loss rate).

7. A data-based reinforcement learning method comprising:
a) allowing an agent (100) to distinguish case 1 (400, 400, 400) in which a reinforcement learning metric (520, 520a, 520b) is higher than an overall average, case 2 (400a, 400a, 400a) in which the reinforcement learning metric (520, 520a, 520b) has no variation compared with the overall average, and case 3 (400b, 400b, 400b) in which the reinforcement learning metric (520, 520a, 520b) is lower than the overall average, and to determine an action such that the reinforcement learning metric (520, 520a, 520b) is maximized with regard to individual piece of data corresponding to stay with regard to a current limit, up by a predetermined value compared with the current limit, and down by a predetermined value compared with the current limit, in each case;
b) allowing a reward control unit (300) to calculate a difference value between an individual variation rate of the reinforcement learning metric (520, 520a, 520b), calculated for the action of the individual piece of data determined by the agent (100), and a total variation rate of a rate of return; and
c) allowing the reward control unit (300) to provide, as a reward for each action of the agent (100), the calculated difference value between the individual variation rate of the reinforcement learning metric (520, 520a, 520b) and the total variation rate of the reinforcement learning metric (520, 520a, 520b),
wherein the calculated difference value is converted into a standardized value between “0” and “1” and provided as a reward.

8. The data-based reinforcement learning method of claim 7, wherein the reinforcement learning metric (520) is configured as a rate of return.

9. The data-based reinforcement learning method of claim 8, wherein the reinforcement learning metric (520a) is configured as a limit exhaustion rate.

10. The data-based reinforcement learning method of claim 9, wherein the reinforcement learning metric (520b) is configured as a loss rate.

11. The data-based reinforcement learning method of claim 10, wherein the reinforcement learning metric (520, 520a, 520b) is obtained such that the individual reinforcement learning metric is configured with a predetermined weight value or different weight values.

12. The data-based reinforcement learning method of claim 11, wherein the reinforcement learning metric (520, 520a, 520b) is configured to determine a final reward by the calculation of the configured weight value of the individual reinforcement learning metric with a standardized variation value, and
the final reward is determined based on the following formula (weight 1*variation value of standardized rate of return)+(weight 2*variation value of standardized limit exhaustion rate)−(weight 3*variation value of standardized loss rate).
